(19) United States
(12) Patent Application Publication
(10) Pub. No.: US 2026/0038392 A1
(43) Pub. Date: Feb. 5, 2026

(54) PIGGYBACK REPLACEMENT LABELS

(71) Applicant: Iconex LLC, Duluth, GA (US)

(72) Inventor: Timothy Darren Livingston, Corryton, TN (US)

(21) Appl. No.: 19/286,134

(22) Filed: Jul. 30, 2025

Related U.S. Application Data
(60) Provisional application No. 63/678,364, filed on Aug. 1, 2024.

(51) Int. Cl. G09F 3/00; G09F 3/02; G09F 3/10

(52) U.S. Cl. CPC G09F 3/0289; G09F 3/10; G09F 2003/0222; G09F 2003/0229; G09F 2003/0241; G09F 2003/0267

(57) ABSTRACT

Label-liner combinations are provided, each label-liner combination includes a liner substrate and a label substrate. The label substrate includes a first adhesive coated on the backside of the label substrate and an adhesive patch atop a portion of the first adhesive in an area that defines a piggyback label within the label substrate. The label substrate further includes die cuts around a periphery of the adhesive patch. The liner substrate includes a back cut for a removal tab of the piggyback label. The front side of the liner substrate is joined with the backside of the label substrate to form a label-liner combination with an embedded and independent piggyback label defined in an area of the label substrate by the adhesive patch, the die cuts, and an area associated with the back cut in the liner substrate for the removal tab.

### RELATED APPLICATIONS

The present application is a non-provisional application of U.S. Provisional Application No. 63/678,364 entitled “Piggyback Replacement Label” filed on Aug. 1, 2024; the disclosure of which is incorporated by reference herein in its entirety.

### BACKGROUND

A piggyback label is a removable label defined within another primary label. The piggyback label is removed from the primary label after the primary label is adhered to a surface of an object. Often piggyback labels require three substrates, two liner substrates and a label substrate for the primary label and the removable label. The three substrates are believed necessary to provide sufficient structural support for label auto applications.

For example, a liner and face stock/label substrate, which includes a single liner die cut for the removable label, weakens the liner when the primary label is separated from the liner by leaving a hole in the liner waste; the hole in the liner waste corresponds to the removable label. A portion of the liner remains attached to the back of removable label when the primary label is separated from the liner with the removable label. The hole's location and size within the liner waste cause jams in a printer. The printer rewinds the waste liner, which is weakened by a large hole corresponding to the removable label and breaks resulting in jams in the waste rewinder of the printer. As a result, piggyback labels include an extra liner substrate consisting of a first liner with no holes (i.e., a waste liner) and a second liner corresponding to the removable label. This ensures the liner waste includes no holes and can be properly rewound by the printer.

### BRIEF DESCRIPTION OF THE DRAWINGS

FIG. 1 is a diagram illustrating a transparent front-side view of a label-liner combination for a piggyback replacement label, according to an example embodiment.

FIG. 2 is a diagram of a backside view of the label-liner combination for the piggyback replacement label, according to an example embodiment.

FIG. 3 is a diagram of a backside view of the label substrate for the label-liner combination of the piggyback replacement label, according to an example embodiment.

FIG. 4 is a diagram a method for manufacturing the label-liner combination with the piggyback replacement label, according to an example embodiment.

### DETAILED DESCRIPTION

As used herein, the term and phrase “liner” and/or “liner substrate” may be used interchangeably and synonymously. Also, the phrases “face stock,” “label substrate,” and “label” may be used interchangeably and synonymously herein and below.

Piggyback labels are useful in a variety of industries for which a single label substrate includes two or more independent labels defined therein with at least one of the independent labels removable for independent application. Manufacturers/Distributors of items, which are shipped to stores or warehouses, often find piggyback labels useful for item packages sent. The primary label identifies a shipping address placed on the package and the removable label or piggyback label identifies a store stock code or store item code. When a store receives the items in a package, the store can remove the independent/piggyback label from the package and apply it to a shelf above the package for easy viewing by store personnel and item restocking by the personnel within the store. Of course, there are a variety of other applications for which piggyback labels are useful.

Auto applicators/printers are used to apply the piggyback labels. A roll or web of the labels are fed into the auto applicator where the piggyback labels are custom imaged, separated from a liner, applied to a package, and the waste liner is rewound into a waste liner roll for disposal or recycling. Because the label is being affixed to a package for transport, the adhesive on the back of the label needs to be a sticky and high tack adhesive, such as hot melt adhesive. The auto applicator uses a peel bar to force separation of the liner from the label to obtain the label and affix it automatically to a surface of a package. The peel bar has to be of a sufficient radius to properly separate the liner from the label. However, the high tack adhesive and die cuts made in the label and/or liner cause the liner waste to be weakened often resulting in tears and rips in the liner substrate and/or the label substrate with the piggyback label. Torn and uneven holes in the liner waste can cause the waste liner rewinder of the applicator to jam. Torn labels can cause the piggyback label to be damaged to a point that is not useful as an independent label when received by a business.

These issues are solved with the piggyback replacement labels and roll of such labels presented herein. The label backside includes a high tack adhesive coating, such as hot melt adhesive coating. A removable microsphere adhesive patch with repositionable adhesive properties is overlaid or printed atop a portion of the high tack adhesive. The portion is the size and dimensions of the piggyback label. Next, the front side of the liner is coated with a release coating and joined to the label. A die cut around a periphery of the removable microsphere adhesive patch within the label substrate is made. A back cut removable tab is made in the liner along an edge portion of the liner corresponding to removable microsphere adhesive patch, wherein the back cut is only made in the liner and not in the label substrate. The result is a label-liner combination with an independent easily removable piggyback label.

A small portion of the liner waste includes a consistent hole representing the removable tab, such that the liner waste does not cause jams when the applicator rewinds the liner waste. Moreover, because of the tab liner portion and the removable microsphere adhesive patch that accompanies the label when the label is auto applied to a package by the applicator, the piggyback label is easily separated from the label on the package and applied to a different object or surface. Furthermore, the piggyback label is repositionable such that it can be removed from one object or surface and reapplied to another object or surface.

The removable microsphere adhesive patch provides repositionable adhesive properties, allowing the piggyback label to be applied to multiple different objects after separation from the original label. The microsphere adhesive maintains sufficient tack for multiple applications while being easily removable and repositionable as needed.

The combination of the back cut tab in the liner, the die cut in the label, and the removable microsphere adhesive patch provides superior structure and integrity to the label-liner combination. The combination also ensures easy removal of the piggyback label from the label on a package with repositionable adhesive for applying the piggyback label to multiple subsequent objects or surfaces.

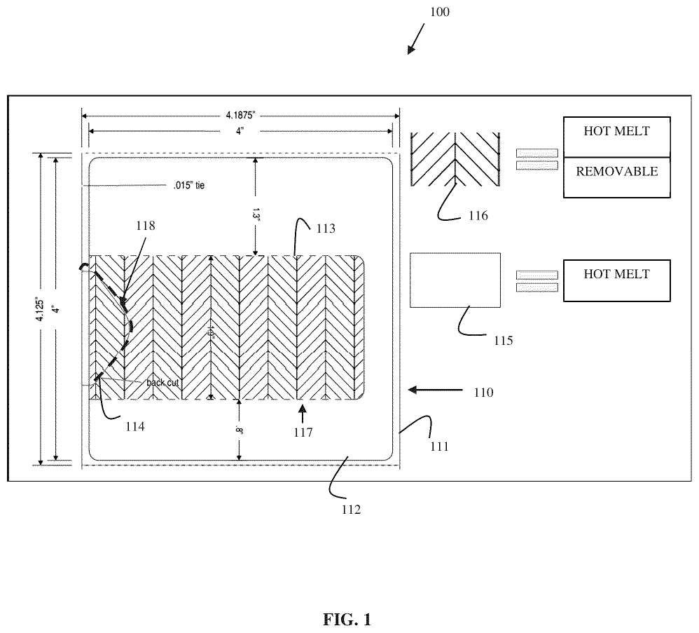

FIG. 1 is a diagram 100 illustrating a transparent front-side view of a label-liner combination 110 for a piggyback replacement label 117, according to an example embodiment. The label-liner combination 110 includes a label 112 and a liner 111. The backside of the label 112 includes a high tack adhesive such as hot melt adhesive 115. The backside of the label 112 also includes a removable microsphere adhesive patch 116 that defines an area on the backside of the label 112 for the piggyback label 117. The removable microsphere adhesive patch 116 is applied over or atop the hot melt adhesive 115.

The label-liner combination further includes liner 110 includes die cuts 113 in the label 112 along a periphery of the removable microsphere adhesive patch 116. The liner 111 includes a back cut 114 defining a removable tab 118.

When an auto applicator processes a roll of the label-liner combination 110, the liner web is separated from the label web and label 112 is ejected with an embedded piggyback label 117. The portion of the liner waste corresponding to the tab 118 leaves a small consistent liner waste edge hole in the liner waste. This improves on liner waste rewinding and mitigates applicator jams when rewinding the liner waste. Further, because the removable microsphere adhesive patch 116 is interposed between the hot melt adhesive 115 and the liner 111, the applicator easily separates the label 112 from the liner web because the microsphere adhesive has less tack than does the hot melt adhesive 115, which also means that the liner 111 does not rip or tear and that the portion defining the tab 118 in the liner easily separates with the label 112.

Once the applicator applies the label 112 to a package or an object, the recipient of the package or object easily removes the piggyback label 117 from the label 112 using tab 118. The removable microsphere adhesive patch 116 is easily removed from the package because the hot melt adhesive 115 is underneath the patch 116 and adhered to the surface of the package or object with remaining portions of the label 112 adhered to the surface of the package or object via the hot melt adhesive 115. Removable of the piggyback label 117 is also facilitated by the die cuts 113.

The repositionable nature of the removable microsphere adhesive patch 116 allows the piggyback label 117 to be moved between different surfaces or objects multiple times without losing adhesive effectiveness. This feature is particularly beneficial in retail and warehouse environments where labels may need to be repositioned for optimal visibility or organization.

In an embodiment, the frontside of the label 112 is coated with a thermal sensitive print or image coating. This allows a thermal printer to image indicia on the frontside of the label 112 and the frontside of the piggyback label 117. In an embodiment, the frontside of the label 112 and the frontside of the piggyback label includes any image or print coating that permits a printer to print or image custom indicia on the label 112 and piggyback label 117.

In an embodiment, the front side liner 111 includes a release coating. In an embodiment, the release coating is a water-based release coating or a silicone-based release coating.

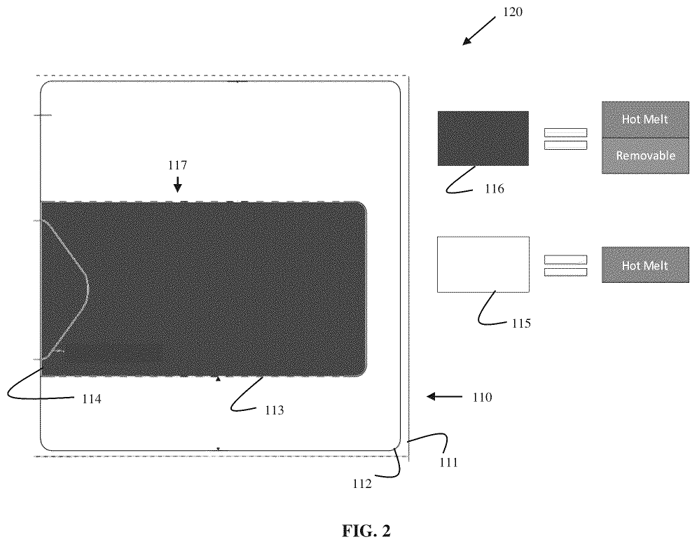

FIG. 2 is a diagram 120 of a backside view of the label-liner combination 110 for the piggyback replacement label 117, according to an example embodiment. The liner 111 is transparent in diagram 120 to further visually illustrate the piggyback label 117.

The blackened area in the diagram 120 represents the removable microsphere adhesive patch 116 that is placed atop and over a flood coated hot melt adhesive 115 along a backside of the label 112. Die cuts 113 in the label 112 around the periphery of the removable microsphere adhesive patch 116 define the area within the label 112 for the piggyback label 117. A back cut 114 in the liner 111 defines the tab 118, which permits easy removal and separation of the piggyback label 117 from the label 112 after the label 112 is affixed to a package or object.

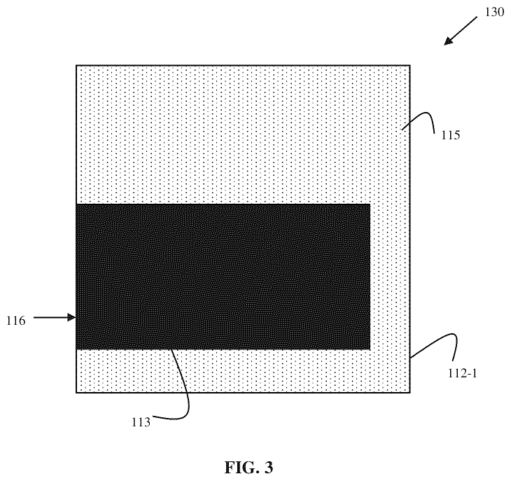

FIG. 3 is a diagram 130 of a backside view of the label 112 for the label-liner combination 110 of the piggyback replacement label 117, according to an example embodiment. The hot melt adhesive 115 is flood coated on the backside of the label 112 and a removable microsphere adhesive patch 116 is placed atop and over the hot melt adhesive 115 such that the adhesive patch 116 is interposed between the liner 111 and interposed between the hot melt adhesive 115 and a surface of a package or object to which the label 112 is subsequently affixed to.

The patch 116 remains affixed to the backside of the label 112 corresponding to the piggyback label 117 when the piggyback label 117 is separated from the label 112. This permits the piggyback label 117 to be reaffixed or adhered to a different object or surface with repositionable adhesive properties. Separation of the piggyback label 117 from the label 112 is also facilitated by die cuts 113 and tab 118, which corresponds to a portion of the liner 111 that remains affixed to the backside of the piggyback label 117. The portion of the liner 111 that remains affixed to a portion of the backside of the piggyback label 117 does not have to be removed to affix the piggyback label 117 to a subsequent object or surface although it can be separated if desired. The removable microsphere adhesive patch 116 has sufficient tack to adhere to any subsequent object or surface even with the liner portion remaining on the backside of the piggyback label 117 and provides repositionable adhesive properties allowing multiple applications.

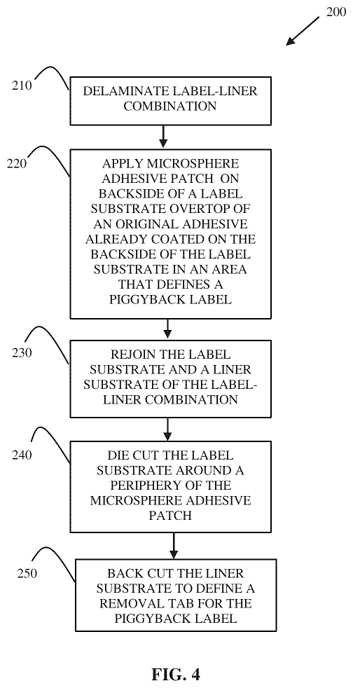

FIG. 4 is a diagram a method 200 for manufacturing rolls of the label-liner combinations 110 with embedded the piggyback replacement labels 117, according to an example embodiment. The method 200 is processed by a press at stations with the electro mechanical components of the press controlled by firmware or software.

At 210, a station of the press, delaminates or separates a liner-label combination to obtain a liner web and a label web. A backside of the liner web includes a release coating while a backside of the label web includes a high tack adhesive such as hot melt adhesive 115. A front side of the label web includes a thermal sensitive print or image coating.

At 220, a station of the press, applies removable microsphere adhesive patches 116 on the backside of the label web overtop of the original high tack adhesive that coats the backside of the label web. Each applied removable microsphere adhesive patch 116 corresponds to a single label-liner combination 110 being defined within the label web. Moreover, each applied removable microsphere adhesive patch 116 is applied in an area along the backside of the label web corresponding to an embedded and independent piggyback label 117.

At 230, a station of the press, rejoins the liner web with the label web to create a web of new label-liner combinations 110. At 240, a station of the press die cuts into the label web around a periphery of each corresponding removable microsphere adhesive patch 116. At 250, a station of the press, back cuts into the liner web a tab 118 for each corresponding removable microsphere adhesive patch 116 forming each of the label-liner combinations with the novel piggyback replacement labels 117.

Although the present invention is described with reference to certain preferred embodiments thereof, variations and modifications of the present invention can be affected within the spirit and scope of the following claims.

1. A label-liner combination, comprising:
a liner substrate;
a label substrate;
a first adhesive coated on a backside of the label substrate;
an adhesive patch placed atop the first adhesive along a portion of the backside of the label substrate, wherein the adhesive patch defines a piggyback label within the label substrate;
die cuts within the label substrate around a periphery of the adhesive patch; and
a back cut tab within the liner substrate corresponding to adhesive patch;
wherein a front side of the liner substrate is joined to the backside of the label substrate to form the label-liner combination with the piggyback label.

2. The label-liner combination of claim 1, wherein a front side of the label substrate includes a thermal sensitive or image coating.

3. The label-liner combination of claim 2, wherein the front side of the liner substrate includes a release coating.

4. The label-liner combination of claim 1, wherein the first adhesive is a hot melt adhesive.

5. The label-liner combination of claim 4, wherein the adhesive patch includes a removable microsphere adhesive.

6. The label-liner combination of claim 1, wherein the adhesive patch comprises a removable microsphere adhesive that is repositionable after the piggyback label is removed from the label substrate.

7. The label-liner combination of claim 1, wherein the back cut tab comprises a small triangular portion of the liner substrate.

8. The label-liner combination of claim 1, wherein the piggyback label remains functional with the adhesive patch and a portion of the liner substrate attached thereto after removal from the label substrate.

9. The label-liner combination of claim 1, wherein the label-liner combination is configured for use with auto applicators.

10. The label-liner combination of claim 1, wherein the die cuts facilitate separation of the piggyback label while maintaining structural integrity of the label-liner combination during auto application.

11. A roll of label-liner combinations, each label-liner combination comprising:
a liner substrate;
a label substrate;
a first adhesive coated on a backside of the label substrate;
an adhesive patch placed atop the first adhesive along a portion of the backside of the label substrate, wherein the adhesive patch defines a piggyback label within the label substrate;
die cuts within the label substrate around a periphery of the adhesive patch; and
a back cut tab within the liner substrate corresponding to the adhesive patch;
wherein a front side of the liner substrate is joined to the backside of the label substrate to form each label-liner combination with the piggyback label.

12. The roll of claim 11, wherein the first adhesive is a hot melt adhesive.

13. The roll of claim 11, wherein the adhesive patch comprises a removable microsphere adhesive.

14. The roll of claim 11, wherein each back cut tab leaves a consistent small hole in liner waste when processed by an auto applicator.

15. The roll of claim 11, wherein the roll is configured for processing by auto applicators with peel bars.

16. The roll of claim 11, wherein each label-liner combination includes a thermal sensitive coating on a front side of the label substrate.

17. The roll of claim 11, wherein the front side of each liner substrate includes a release coating.

18. The roll of claim 11, wherein the roll mitigates applicator jams during liner waste rewinding.

19. A method for manufacturing label-liner combinations with piggyback replacement labels, comprising:
delaminating or separating a liner-label combination to obtain a liner web and a label web, wherein a backside of the liner web includes a release coating and a backside of the label web includes a high tack adhesive;
applying removable microsphere adhesive patches on the backside of the label web, overtop of the high tack adhesive, each applied removable microsphere adhesive patch corresponding to a piggyback label area;
rejoining the liner web with the label web to create a web of label-liner combinations;
die cutting into the label web around a periphery of each corresponding removable microsphere adhesive patch; and
back cutting into the liner web a tab for each corresponding removable microsphere adhesive patch.

20. The method of claim 19, wherein the high tack adhesive comprises hot melt adhesive and the removable microsphere adhesive patches provide repositionable adhesive properties.
